(19) United States
(12) Patent Application Publication
(10) Pub. No.: US 2006/0082682 A1
(43) Pub. Date: Apr. 20, 2006

(54) Camera LCD screen viewing device

(75) Inventor: Robert P. Schmidt, West Hollywood, CA (US)

Correspondence Address: Christopher J. Fildes;Fildes & Outland, P.C., Suite 2, 20916 Mack Avenue, Grosse Pointe Woods, MI, 48236, US

(73) Assignee: Hoodman Corporation

(21) Appl. No.: 10/966,695

(22) Filed: Oct. 15, 2004

(51) Int. Cl. H04N 5/225; H04N 5/222; H04N 9/47; H04N 7/18

(52) U.S. Cl. 348/375; 348/333.08

(57) ABSTRACT

A camera LCD screen viewing device includes a LCD screen cover member having an open mounting end, a sidewall, and an opposite viewing end. The cover member has a lens disposed in the viewing end. The cover member also includes a mount adapted to mount the cover member mounting end about the camera LCD screen. Mounting the device to a camera allows for the camera LCD screen to be viewed as with a conventional camera viewfinder and for the elimination of glare while viewing.

### TECHNICAL FIELD

This invention relates to digital camera devices, and more particularly to devices for viewing camera LCD screens while also shielding LCD screens from glare.

### BACKGROUND OF THE INVENTION

It is known in the art relating to digital cameras that when digital cameras with LCD screens are used in bright light, such as outdoors in the sunlight, it is difficult to view the camera's LCD screen. The glare resulting from the sunlight “washes out” the image on the LCD screen. Often, a photographer has to shield the camera LCD screen in order to be able to view the screen. This is cumbersome and hinders the photographer's composing and taking of a picture. It also makes it difficult for the photographer to view the LCD screen when reviewing previously-taken pictures stored in, for example, the camera's memory card.

Further, users of digital cameras with LCD screens often hold the camera at an extended distance from their eyes in order to view the screen when composing and taking a picture. For example, users of digital cameras often hold their cameras in both hands with both of their arms nearly fully extended at an elevation level with their heads. In this position, it is difficult to view the camera's LCD screen because of the distance between the screen and the user's eyes.

It is also difficult to compose a picture in this position. This is especially true for beginning users of digital cameras. Conventionally, as with the use of analog cameras, the camera is held up to the user's eyes and head. The user then moves his/her head up and down and/or left and right to adjust the aim/view of the camera. This is a natural motion as it mimics the motion one would normally use to view objects with the naked eye. In contrast, when using a digital camera as described above, instead of moving one's head, the user must rotate and tilt the camera with his/her hands to adjust the aim/view of the camera in order to compose a picture. This is an unnatural motion and is hard for some digital camera users to learn and perfect.

### SUMMARY OF THE INVENTION

The present invention provides a camera accessory that is securable about an LCD screen of a digital camera. The camera accessory of the present invention is a camera LCD screen viewing device that is usable with both “swing-out” LCD screens and LCD screens that are built into the body of the camera. In this way, the viewing device is universally usable with a multitude of brands and models of cameras. The viewing device of the present invention both allows for close and accurate viewing of the LCD screen while also shielding the LCD screen from bright light such as sunlight. When the viewing device is secured about an LCD screen, the viewing device turns the LCD screen into a viewfinder. This allows a user to view the LCD screen at close proximity to his/her eye when, for example, composing a picture or viewing previously-taken pictures. Furthermore, the viewing device of the present invention is collapsible into itself for compact and easy storage when not in use.

More particularly, a camera LCD screen viewing device in accordance with the present invention includes a LCD screen cover member having an open mounting end, a sidewall, and an opposite viewing end. The cover member has a lens disposed in the viewing end. The cover member also includes a mount adapted to mount the cover member mounting end about the camera LCD screen. Mounting the device to a camera allows for the camera LCD screen to be viewed as with a conventional camera viewfinder and for the elimination of glare while viewing.

The sidewall may have an adjustable length allowing for adjustment of the position of the viewing end. Further, the viewing end may be adjustable between at least two positions. The lens may magnify an image displayed on the camera LCD screen and the lens may have a magnifying power of 2:1. The device may be made of a flexible material, which may be a rubber material, a polymer, or similar. A lens cup may extend outwardly from the viewing end. The open mounting end may have a cross-sectional shape generally corresponding in size and shape to a camera LCD screen.

In a specific embodiment, the mount may include at least one pair of mating ears, each mating ear of the pair of mating ears projecting from an opposite portion of the sidewall and each mating ear including a slot therein. The mount may also include an elongated strap receivable in the slots of the mating ears. The strap includes a stop at one end for preventing that end of the strap from being capable of passing through the mating ears. The strap may be mated with one mating ear of the pair of mating ears at the stop and may be mated with the other mating ear of the pair via an end of the strap opposite the stop. The mount may further include two pairs of mating ears. The strap may include a plurality of indexing members. The indexing members may be slanted, peaked teeth. The strap may also include a taper at the end opposite the stop to allow for easier insertion of the strap into the slots of the mating ears.

In an alternative embodiment, the mount may be adapted to mount the camera LCD screen viewing device to other devices. The mount may further include a plurality of notches on an inner portion of the sidewall near the open mounting end.

These and other features and advantages of the invention will be more fully understood from the following detailed description of the invention taken together with the accompanying drawings.

### BRIEF DESCRIPTION OF THE DRAWINGS

In the drawings:

FIG. 1 is a perspective view of a camera LCD screen viewing device in accordance with the present invention;

FIG. 2 is a view of the mounting end of the device of FIG. 1;

FIG. 3 is a view of the viewing end of the device of FIG. 1;

FIG. 4 is a perspective view of the device of FIG. 1 showing a storage position of the device wherein a sidewall of the device has been adjusted into a collapsed position;

FIG. 5 is a perspective view of the device of FIG. 1 secured to a camera LCD screen;

FIG. 6 is a perspective view of the device of FIG. 1 secured to a “swing-out” camera LCD screen;

FIG. 7 is a perspective view of an alternative embodiment of a camera LCD screen viewing device in accordance with the present invention; and

FIG. 8 is a perspective view of the device of FIG. 7 secured to another device.

### DETAILED DESCRIPTION OF THE INVENTION

Referring now to the drawings in detail, numeral 10 generally indicates a camera LCD screen viewing device in accordance with the present invention. The viewing device 10 is adapted for use with a digital camera 12 having an LCD screen 14. As is hereinafter more fully described, when secured to a camera LCD screen, the viewing device 10 turns the LCD screen into a viewfinder for close and accurate viewing of the screen and shields the LCD screen from bright light such as sunlight.

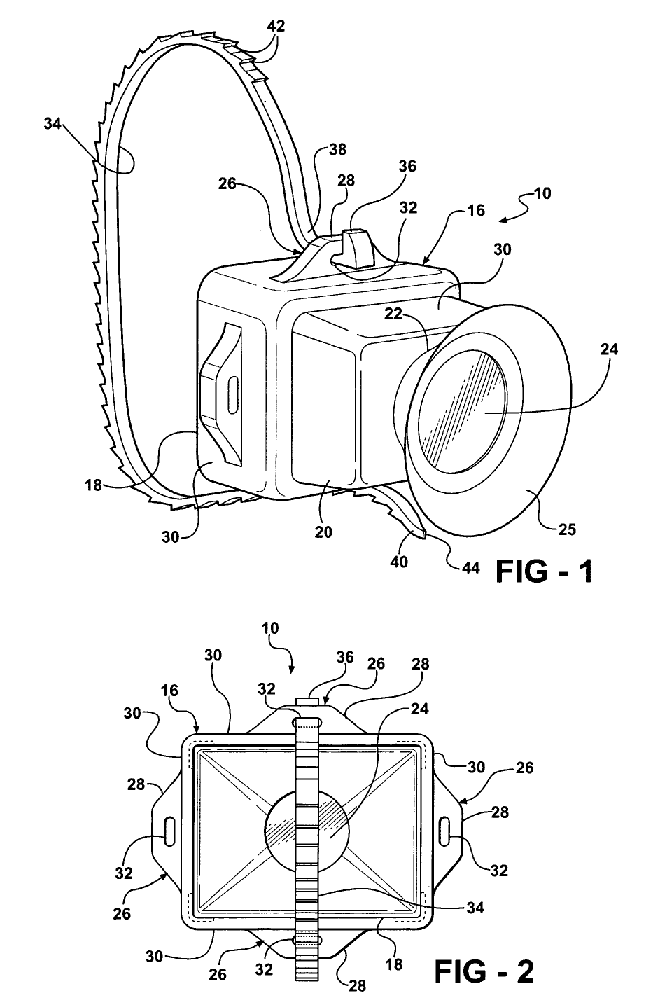

FIGS. 1 through 6 illustrate a first embodiment of the present invention. As shown in these Figures, the viewing device 10 includes a LCD screen cover member 16 having an open mounting end 18, a sidewall 20, and an opposite viewing end 22. The cover member 16 has a lens 24 disposed in the viewing end 22. The cover member 16 also includes a mount 26 adapted to mount the cover member mounting end 18 about the camera LCD screen 14. The mount 26 may be a strap, Velcro, a snap, a receiver, or similar. Mounting the device 10 to a camera 12 allows for the camera LCD screen 14 to be viewed as with a conventional camera viewfinder and allows for the elimination of glare while viewing.

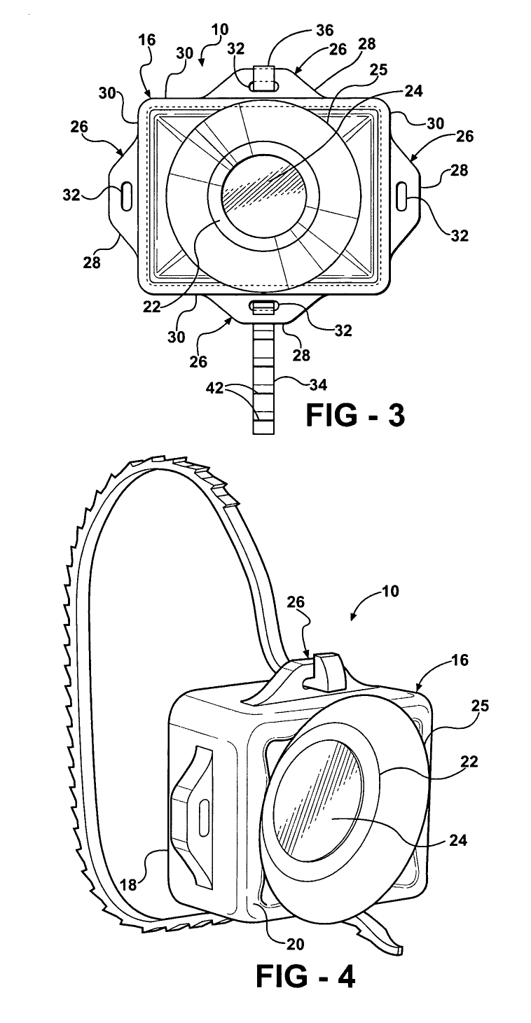

In this embodiment, the sidewall 20 may have an adjustable length allowing for adjustment of the position of the viewing end 22. The sidewall 20 may generally form a box-like shape near the open mounting end 18. In contrast, near the viewing end 22, the sidewall 20 may generally form a truncated pyramid-like shape. Further, the sidewall 20 may have variable thickness such that the thickness of the sidewall in the portion that is pyramid-like in shape may be less than the thickness of the portion that is box-like in shape. The viewing end 22 may thereby be adjustable between at least two positions. In one position, the sidewall 20 is fully expanded along a viewing axis of the device 10 for use of the device 10. In the other position as shown in FIG. 4, the sidewall 20 is contracted, collapsing sidewall 20 of the cover member 16 into itself for compact storage of the device 10.

The lens 24 may magnify an image displayed on the camera LCD screen 14 and may have a magnifying power of generally 2:1. The lens 24 thereby increases the size of the image displayed on the LCD screen 14 and allows a camera user's eye to focus on the LCD screen at a focal length at which the naked eye cannot focus upon. This is possible because the focal length of the lens 24 is a length shorter than a minimum distance at which a user's naked eye can focus.

The viewing device 10 may be made of a flexible material. The material may be a rubber material, a polymer, or similar.

The viewing device 10 may include a lens cup 25 that extends outwardly from the viewing end 22. The cup 25 shields the lens 24 from light, allowing for improved viewing when a user of the device 10 looks through the lens. The open mounting end 18 may have a cross-sectional shape generally corresponding in size and shape to a camera LCD screen 14.

The mount 26 may include at least one pair of mating ears 28, each mating ear 28 of the pair of mating ears projecting from an opposite portion 30 of the sidewall 20 and each mating ear 28 including a slot 32 therein. The mount 26 may also include an elongated strap 34 receivable in the slots 32 of the mating ears 28. The strap 34 includes a stop 36 at one end 38 for preventing that end of the strap from being capable of passing through the mating ears 28. The strap 34 may be mated with one mating ear 28 of the pair of mating ears at the stop 36 and may be mated with the other mating ear 28 of the pair via an end 40 of the strap opposite the stop.

The mount 26 may further include two pairs of mating ears 28. This allows the strap 34 to be oriented in generally a horizontal direction or in generally a vertical direction in relation to the camera LCD screen 14. The strap 34 may include a plurality of indexing members 42. The indexing members 42 may be slanted, peaked teeth. For example, the indexing members 42 may be teeth having a right-triangular shape. The strap 34 may also include a taper 44 at the end 40 opposite the stop 36 to allow for easier insertion of the strap into the slots 32 of the mating ears 28.

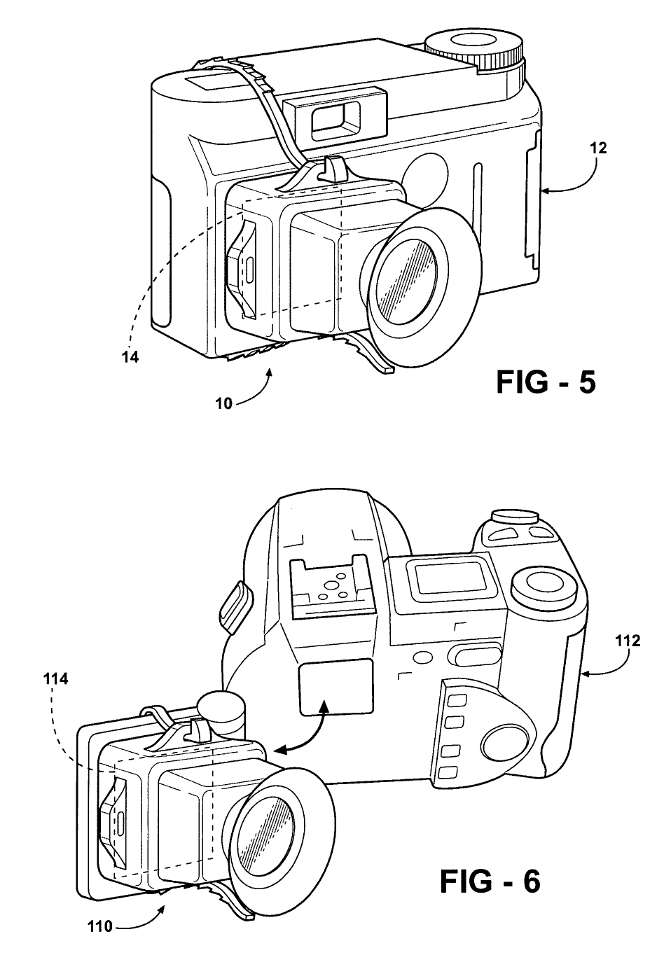

As shown in FIGS. 5 and 6, the viewing device 10 is usable with cameras having “swing-out” LCD screens or those having LCD screens that are built into the body of the camera. In FIG. 5, the viewing device 10 has been secured to a camera 12 having an in-body LCD screen 14. In FIG. 6, the viewing device 110 has been secured to a camera 112 having a “swing-out” LCD screen 114.

The viewing device 10 is secured about a camera LCD screen 14 in the following manner. The mounting end 18 is first disposed about the LCD screen 14 so that the cover member 16 covers the LCD screen. In the case that the viewing device 10 is being used with an in-body LCD screen 14 (FIG. 5), the strap 34 is then wrapped around the body of the camera 12. Alternatively, in the case that the viewing device 110 is being used with a “swing-out” LCD screen 114 (FIG. 6), the strap 34 is then wrapped around the body of the LCD screen 114. If the end 40 of the strap 34 is not already inserted into a slot 32 of a mating ear 28, the strap is inserted into the slot of the mating ear opposite the mating ear wherein the opposite end 38 of the strap is inserted. Next, the strap 34 is tightened by pulling the strap and indexing members 42 through the slot 32 of the mating ear 28. The strap 34 is tightened until the viewing device 10 rests snuggly against the camera LCD screen 14.

Once the viewing device 10 is secured to the camera LCD screen 14, a camera user may put his or her eye up to the viewing end 22 of the device in order to look through the lens 24. This allows the user to view the LCD screen 14 as a conventional camera viewfinder. If the lens 24 has a magnifying power, then the image from the LCD screen that the user sees through the viewing device 10 is magnified. This allows the user to see the image in greater detail. Further, if the camera 12 is being used in bright light, such as in outdoor sunlight, the viewing device 10 shields the LCD screen 14 from the bright light, thereby eliminating glare on the LCD screen. Hence, the image the user sees is much clearer.

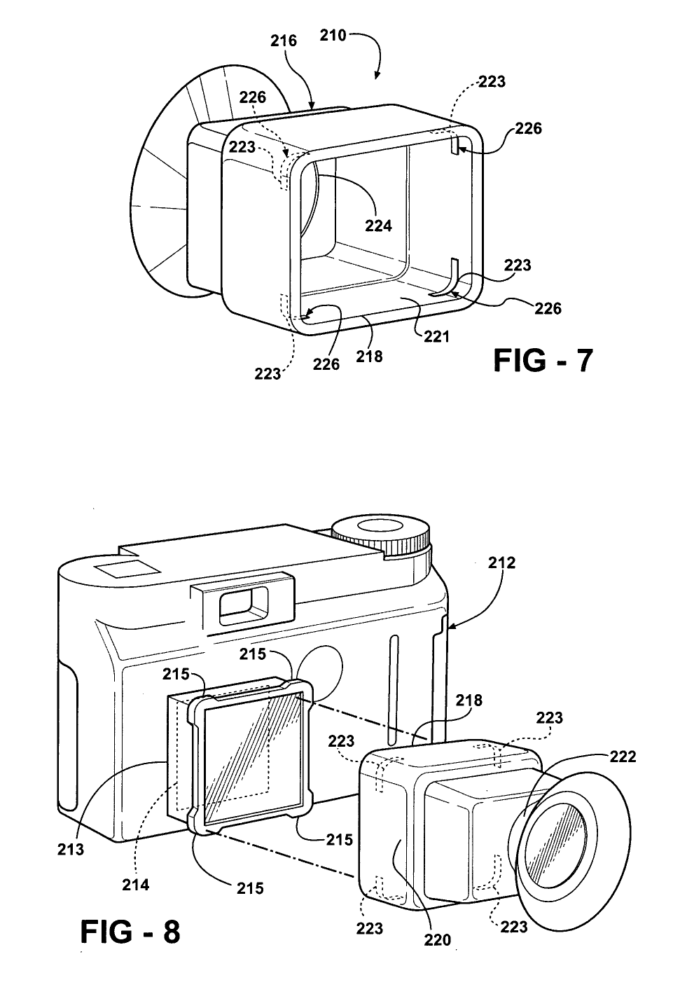

FIGS. 7 and 8 illustrate an alternative embodiment of the present invention. As shown in these Figures, the viewing device 210 includes a LCD screen cover member 216 having an open mounting end 218, a sidewall 220, and an opposite viewing end 222. The cover member 216. has a lens 224 disposed in the viewing end 222. The cover member 216 also includes a mount 226 adapted to mount the cover member mounting end 218 about the camera LCD screen 214. Mounting the device 210 to a camera 212 allows for the camera LCD screen 214 to be viewed as with a conventional camera viewfinder and allows for the elimination of glare while viewing.

In this alternative embodiment, the mount 226 may be adapted to mount the viewing device 210 to other devices, such as protective LCD screen caps or similar, that are intermediate the camera 212 and the LCD screen 214. The mount 226 may include a plurality of notches 223 disposed on an inner portion 221 of the sidewall 220 near the open mounting end 218. The notches 223 facilitate the mounting of the device 210 about a camera LCD screen 214. For example, prior to mounting the device 210 to the camera 212, a protective LCD cap 213 may be mounted over the LCD screen 214. The device 210 may then be mounted about the LCD screen 214 by placing the open mounting end 218 over the protective LCD cap 213 and inserting outer edges 215 of the LCD cap into the notches 223. The device 210 is thereby held securely about the LCD screen 214.

The viewing device 210 may also include similar optional features as described in the first embodiment above. Further, the viewing device 210 may also include the optional features of the mount 26 of the first embodiment of the viewing device 10. Specifically, the viewing device 210 may include both notches 223 as well as the mating ears 28 and strap 34 as described above. This allows the viewing device 210 to either be mounted about a camera LCD screen via the mating ears 28 and strap 34 or to be mounted via the notches 223 to a separate device, such as a protective LCD cap, that is mounted over a camera LCD screen.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A camera LCD screen viewing device comprising:
a LCD screen cover member having an open mounting end, a sidewall, and an opposite viewing end;
said cover member having a lens disposed in said viewing end;
said cover member including a mount adapted to mount the cover member mounting end about the camera LCD screen;
whereby mounting said device to a camera allows for the camera LCD screen to be viewed as with a conventional camera viewfinder and for the elimination of glare while viewing.

2. The camera LCD screen viewing device of claim 1, wherein said sidewall has an adjustable length allowing for adjustment of the position of said viewing end.

3. The camera LCD screen viewing device of claim 2, wherein said viewing end is adjustable between at least two positions.

4. The camera LCD screen viewing device of claim 1, wherein said lens magnifies an image displayed on the camera LCD screen.

5. The camera LCD screen viewing device of claim 1, wherein said lens has a magnifying power of generally 2:1.

6. The camera LCD screen viewing device of claim 1, wherein said device is made of a flexible material.

7. The camera LCD screen viewing device of claim 6, wherein said material is one of a rubber and a polymer.

8. The camera LCD screen viewing device of claim 1, wherein a lens cup extends outwardly from said viewing end.

9. The camera LCD screen viewing device of claim 1, wherein said open mounting end has a cross-sectional shape generally corresponding in size and shape to a camera LCD screen.

10. The camera LCD screen viewing device of claim 1, wherein said mount includes:
at least one pair of mating ears, each mating ear of said pair of mating ears projecting from an opposite portion of said sidewall and each mating ear including a slot therein; and
an elongated strap receivable in said slots of said mating ears, said strap including a stop at one end for preventing said one end of said strap from being capable of passing through said mating ears;
said strap being mated with one mating ear of said pair of mating ears at said stop and being mated with said other mating ear of said pair via an end of said strap opposite said stop.

11. The camera LCD screen viewing device of claim 10, wherein said mount includes two pairs of mating ears.

12. The camera LCD screen viewing device of claim 10, wherein said strap includes a plurality of indexing members.

13. The camera LCD screen viewing device of claim 12, wherein said indexing members are slanted, peaked teeth.

14. The camera LCD screen viewing device of claim 10, wherein said strap includes a taper at said end opposite said stop to allow for easier insertion of said strap into the slots of said mating ears.

15. The camera LCD screen viewing device of claim 1, wherein said mount is adapted to mount the camera LCD screen viewing device to other devices.

16. The camera LCD screen viewing device of claim 15, wherein said mount includes a plurality of notches disposed on an inner portion of said sidewall near said open mounting end.
